(19) United States
(12) Patent Application Publication
(10) Pub. No.: US 2011/0186313 A1
(43) Pub. Date: Aug. 4, 2011

(54) Dirt Hole Closer

(76) Inventor: Robert Lewis Hawkins, Hart, TX (US)

(21) Appl. No.: 12/697,229

(22) Filed: Jan. 30, 2010

(51) Int. Cl. E02F 3/815; E02F 1/00; A01B 79/00; E02F 5/00

(52) U.S. Cl. 172/1; 172/664

(57) ABSTRACT

A dirt hole closer is attached to the front of a skid steer, or to a tractor, forklift, or the like and consists of a frame, a push blade, a left arm, and a right arm. The frame is removably attached to the lifting mechanism of the vehicle. The push blade, the left arm, and the right arm are attached to the frame and have coplanar lower edges. Both the left arm and the right arm can be manipulated, by means such as hydraulic actuators. The dirt hole closer provides a novel method of planting trees or setting posts or poles and utilizes both linear and angular motion to push excavated dirt into the annulus of hole surrounding the object being planted.

### FIELD OF THE INVENTION

This invention relates to an earth working apparatus for filling holes in connection with landscaping, agricultural work, and construction. Specifically, this invention relates to earth working equipment having a push blade and arm mounted blades that are used to fill holes in applications such as planting trees and shrubs, setting posts or poles, and the like, in a safe and efficient manner.

### BACKGROUND

The methods and equipment utilized to plant trees, shrubs, posts, poles, or other objects into the ground are substantially similar. That is, in each scenario, there exists a need to backfill the area around the object being planted using the excavated dirt that surrounds the hole with the item being planted protruding above ground level. For purposes of illustration, the example of planting a tree will be utilized; however, analogies between the various operations should be readily apparent.

Planting a tree essentially requires three major steps: digging a hole large enough to accommodate the tree, inserting the tree, and backfilling the annulus of the hole with the excavated dirt. In small scale operations such as residential applications, these steps are generally performed by hand. In larger operations such as agricultural operations or urban forestry projects, it is desirable to have an apparatus available to perform these steps. While it is common to utilize augers to perform the step of making the hole, most backfilling operations have heretofore been performed by hand. Performing the backfilling operation by hand is time and labor intensive and, therefore, not efficient or cost-effective. This inefficiency increases with the number of trees being planted. Similar inefficiencies are present when planting a large number of fence posts, utility poles, sign posts, etc.

A variety of earth working attachments having different sizes, shapes, and orientations of blades are commonly utilized to manipulate dirt to fill holes and trenches and to level surfaces. In some instances, the earth working device is designed to be pushed in front of the vehicle and in other instances the earth working device is designed to be pulled behind the vehicle. In some applications, the devices are designed to level the surface and prepare seed beds. Still in other applications, devices are specially designed to fill trenches.

In many cases, these attachments utilize a single blade that may be manipulated during operation by lifting, turning, and/or tilting the blade using hydraulics. In some instances, these manipulations are effectuated by the movement of lifting arms or hydraulic actuators located on the vehicle while in other cases there may be hydraulic actuators mounted on the attachment itself. In some cases, the prior art utilizes multiple blades (or grading surfaces) that can be adjusted and positioned to achieve different results. The multiple blade configurations may be designed to be manually or remotely manipulated. In cases where the blades and grading surfaces can be manipulated, the blades and grading surfaces typically effectuate their purpose while in a fixed position. In these cases, the devices rely primarily on the forward or backward linear movement of the vehicle to move the dirt.

The reliance on the linear movement of the vehicle to move the dirt may not optimize these devices for back filling dirt hole in connection with planting an object. That is, the shape of the hole combined with the presence of the object in the hole may require the operator to make multiple back and forth movements to back fill the excavated dirt in the annulus of the hole. In addition, use of a blade, scraper, or leveling device is generally too cumbersome to control in a manner that would provide complete backfilling of the hole. In that case, remedial backfilling of the hole may be needed. Accordingly, it would be advantageous to have an earth working attachment that allowed the operator to completely back fill the hole around the object being planted with one forward and one backward movement of the vehicle.

Information relevant to attempts to address these problems can be found in U.S. Pat. Nos.: 5,775,438; 6,139,223; 7,273,111 B2; 4,268,187; U.S. Pat. No. 6,523,699 B1; 1,799,424; U.S. Pat. Nos. 6,315,056; 5,988,295; 5,511,625; 3,336,685; 4,892,155; 5,806,605; and U.S. Pat. No. 6,467,552 B1. However, each one of these references suffers from one or more of the following disadvantages: they rely primarily on multiple forward and backward movements of the vehicle to effectuate their purpose; they do not provide a means to readily manipulate the filler material into a hole with an object projecting above the ground level; they are too bulky and cumbersome to ensure that the annulus of the hole is sufficiently backfilled; they have a significant number of moving parts; and they are complex and difficult to manufacture. For the foregoing reasons, there is a need for a dirt hole closer that overcomes the shortcomings of the prior art.

### SUMMARY

The present invention is directed to a dirt hole closer that satisfies this need because: it utilizes the linear motion of the vehicle and the angular motion of the blades to move dirt; it provides a means to readily manipulate the filler material into a hole with an object projecting above the ground level; it can be readily controlled to ensure that hole is sufficiently backfilled; it has a minimum number of moving parts; and it is simple and easy to manufacture.

The dirt hole closer is adapted to be secured to the front of a skid steer, or to a tractor, forklift, front-end loader, or the like and consists of a frame, a push blade, a left arm, and a right arm. The frame is attached to the vehicle using a universal plate or other similar means known in the art. The push blade is rigidly attached to the frame. The left arm and the right arm are pivotally attached to the frame. Both the left arm and the right arm can be manipulated by means such as hydraulic actuators. The right arm actuator is attached to the frame and the right arm. The left arm actuator is attached to the frame and the left arm.

The present invention is further directed to a method for backfilling an annulus of a hole surrounding an object to be planted using a dirt hole closer, the method comprising configuring the dirt hole closer in an open configuration; positioning the dirt hole closer so that it contacts the ground; linearly moving the dirt hole closer toward the object to be planted thereby forcing excavated dirt into the annulus of the hole; positioning the arms of the dirt hole closer in a closed configuration thereby forcing excavated dirt into the annulus of the hole using angular motion; tilting the dirt hole closer downward; backing the dirt hole closer away from the tree thereby forcing the remaining excavated dirt to enter the annulus of the hole using linear motion; leveling the dirt hole closer; and positioning the arms of the dirt hole closer in an open configuration.

### BRIEF DESCRIPTION OF THE DRAWINGS

These and other features, aspects, and advantages of the present invention will become better understood with regard to the following description, appended claims, and accompanying drawings where:

FIG. 1 is a front isometric view of the dirt hole closer preparing to fill a hole, according to some embodiments.

FIG. 2 is a front isometric view of the dirt hole closer (of FIG. 1) linearly moving dirt to the hole to be filled, according to some embodiments.

FIG. 3 is a front isometric view of the dirt hole closer (of FIG. 1) angularly moving dirt to the hole to be filled, according to some embodiments.

FIG. 4 is a front isometric view of the dirt hole closer (of FIG. 1) and the backfilled hole, according to some embodiments.

FIG. 5 is a plan view of the dirt hole closer (of FIG. 1), according to some embodiments.

FIG. 6 is a rear view of the frame of the dirt hole closer (of FIG. 1), according to some embodiments.

FIG. 7 is a side view of the frame of the dirt hole closer (of FIG. 1), according to some embodiments.

FIG. 8 is a plan view of the left arm of the dirt hole closer (of FIG. 1), according to some embodiments.

FIG. 9 is a side view of the left arm of the dirt hole closer (of FIG. 1) as viewed from the right side, according to some embodiments.

FIG. 10 is a side view of the left arm of the dirt hole closer (of FIG. 1) as viewed from the left side, according to some embodiments.

FIG. 11 is a flow diagram for a method to perform a dirt hole filling operation, according to some embodiments.

### DETAILED DESCRIPTION

According to the present invention, a dirt hole closer is disclosed. The dirt hole closer is an attachment for a vehicle such as a skid steer, tractor, forklift, front-end loader, or the like that allows an operator to use the vehicle to back fill excavated dirt when planting trees, shrubs, fence posts, poles, or other similar objects. The disclosed dirt hole closer may attain many configurations. In one embodiment, the dirt hole closer includes a frame, a push blade, a right arm, a right arm actuator, a left arm, and a left arm actuator. The frame is attached to the skid steer and the push blade, right arm, and left arm are attached to the frame. The right arm actuator is connected to the frame and the right arm. The left arm actuator is connected to the frame and the left arm. The left arm and the right arm are positioned opposite of each other.

The frame is the structural foundation of the dirt hole closer. The frame includes a rear, a left side, a right side, and a front. The rear abuts flush with the universal plate of the skid steer so that the frame may be removably attached to the lift arms of the skid steer as is commonly known in the art. The frame may also be configured to include an integrated universal plate, thereby eliminating the need for a separate universal plate. The rear includes two horizontal members each having two mounting holes.

The left side and right side each include an upper horizontal member, a lower horizontal member, a vertical member, a hinge, and a pin support. The front includes a brace that is attached to the vertical members of the left side and right side. The push blade is located in the front of the frame and is attached to the brace and the vertical members of the left side and right side. The push blade utilizes the linear motion of the vehicle to move dirt in the direction of travel of the vehicle.

The left arm and the right arm each include a support member, a blade, a hinge support, and a brace. The support member has a straight section and a curved section. The blade is securely attached to the support member and the hinge support is securely attached to the blade and the support member. The brace is securely attached to the support member and the blade. The left arm and the right arm are pivotally attached to the left side of the frame and the right side of the frame, respectively. The left arm and the right arm are pivotally secured to the frame at the hinges by a pin that passes through the hinge, the support member, the pivot brace, and the hinge support.

Both the left arm and the right arm are manipulated using hydraulic actuators. The left arm and the right arm are configured for coplanar manipulation. A left arm actuator is connected to the left arm and a right block. The right block is rigidly mounted on the right side of the frame. A right arm actuator is connected to the right arm and the left block. The left block is rigidly mounted on the left side of the frame. The right block and the left block provide static attachment points for the respective actuators. The left arm and right arm provide dynamic attachment points for the respective actuators. The left and right arms are manipulated by the movement of the actuators.

The actuators and the arms are configured so the dirt hole filler can be in an opened or closed position. In the open position, the left arm and the right arm are substantially perpendicular to the direction of travel of the vehicle. In this position, the push blade, the left arm, and the right arm move dirt in the direction of travel of the vehicle toward the hole containing the object being planted. When the arms are moved into the closed position, the angular motion of the arms translates dirt toward the middle of the dirt hole closer thereby pushing the excavated dirt into the annulus of the hole. The arms are then lowered in the front (the side opposed to the vehicle) by manipulating the lifting arms of the skid steer and the vehicle is backed away from the hole to complete filling the hole. The arms are then repositioned in the open position and raised. Then, the vehicle is moved away from the object that was planted in preparation for the next backfilling operation. Throughout a given backfilling operation, the dirt hole filler may be raised, lowered, and or tilted using the skid steer, as needed, to position the blades and to help ensure that a significant amount of the excavated dirt is positioned in the annulus of the hole and around the planted object.

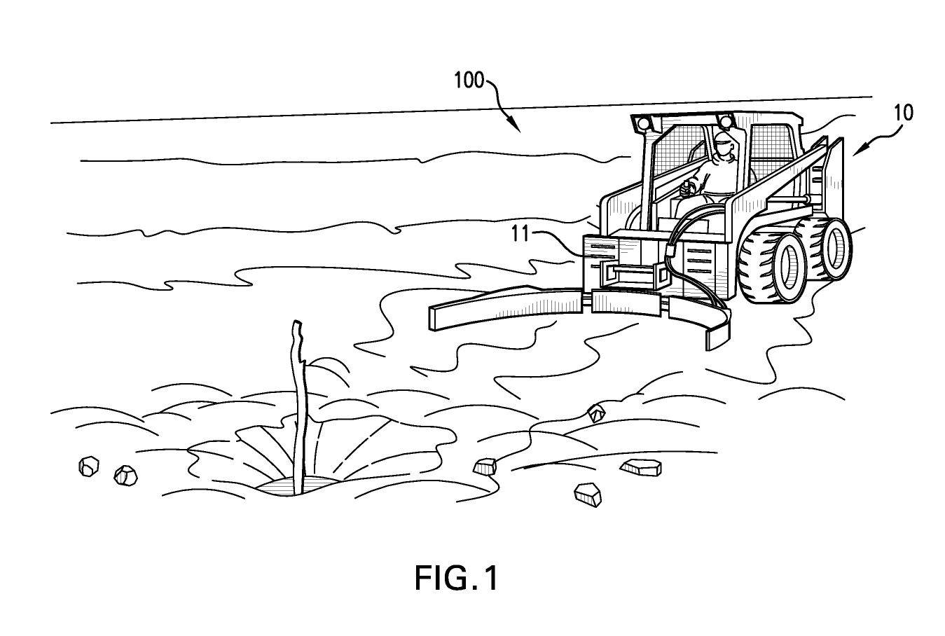

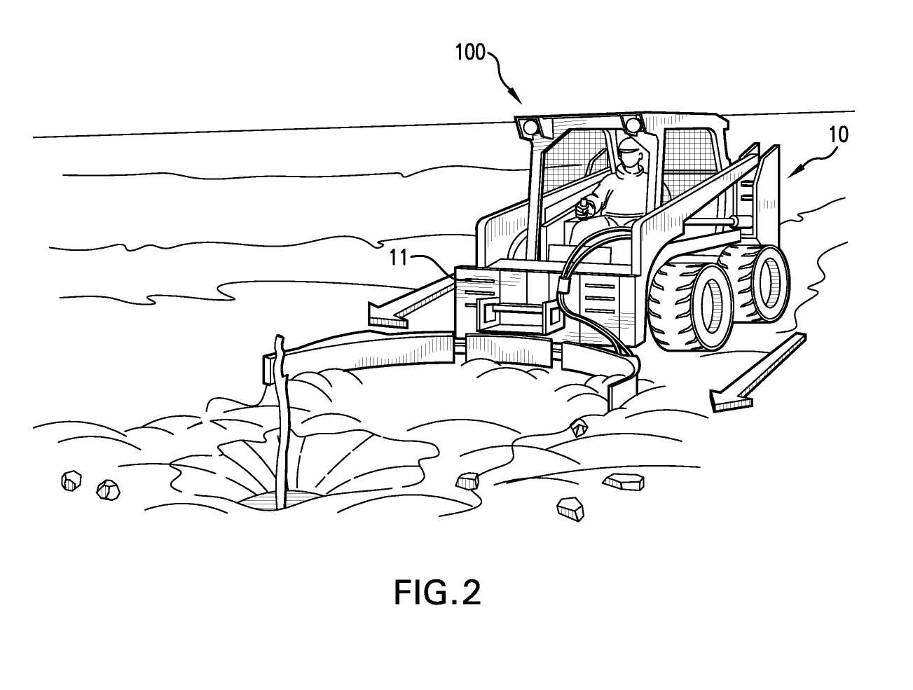

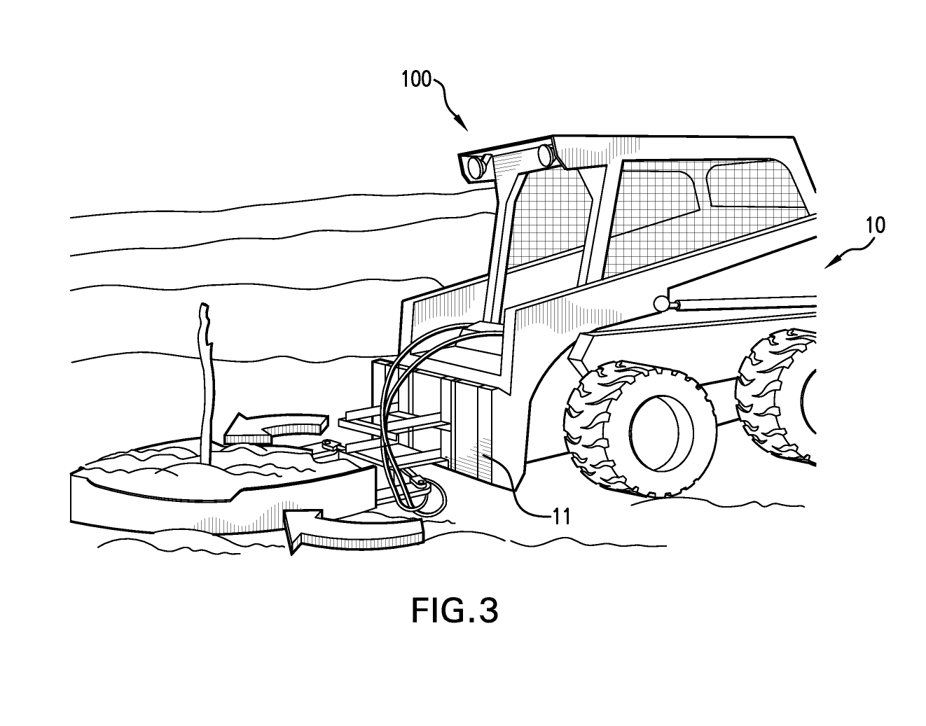

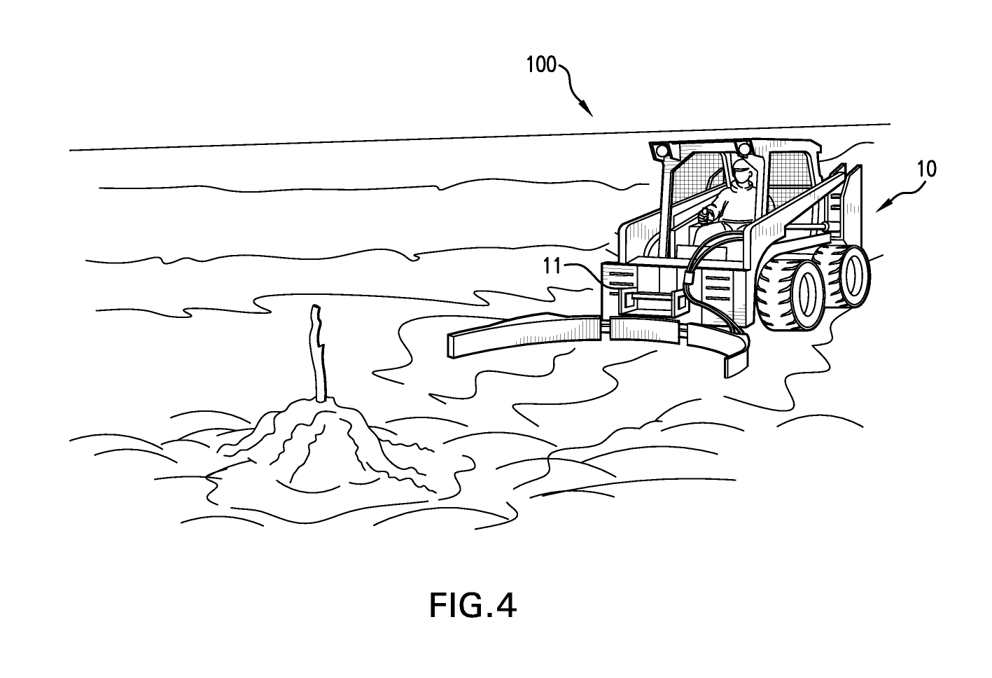

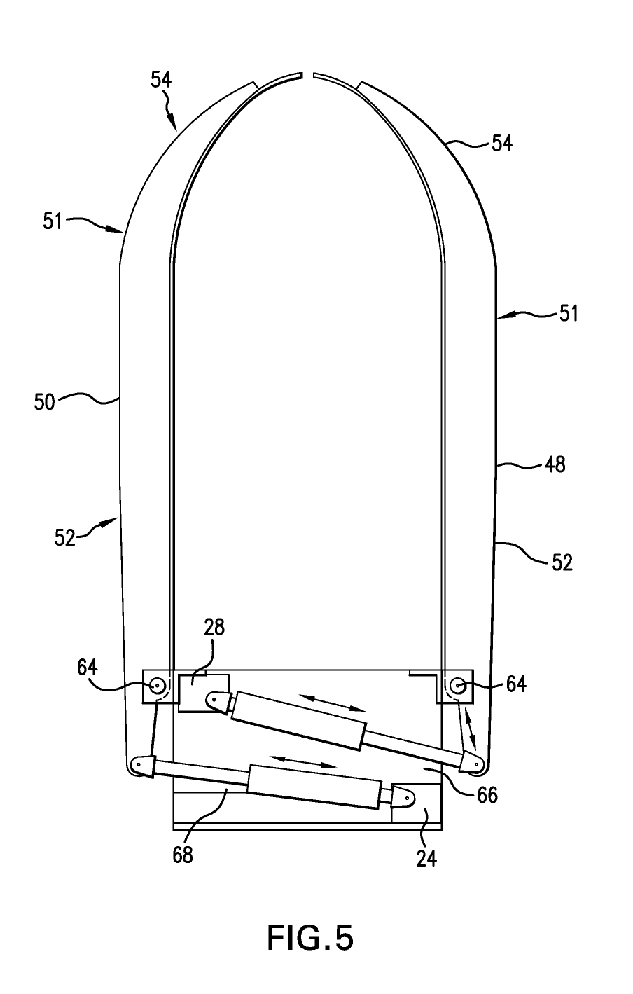

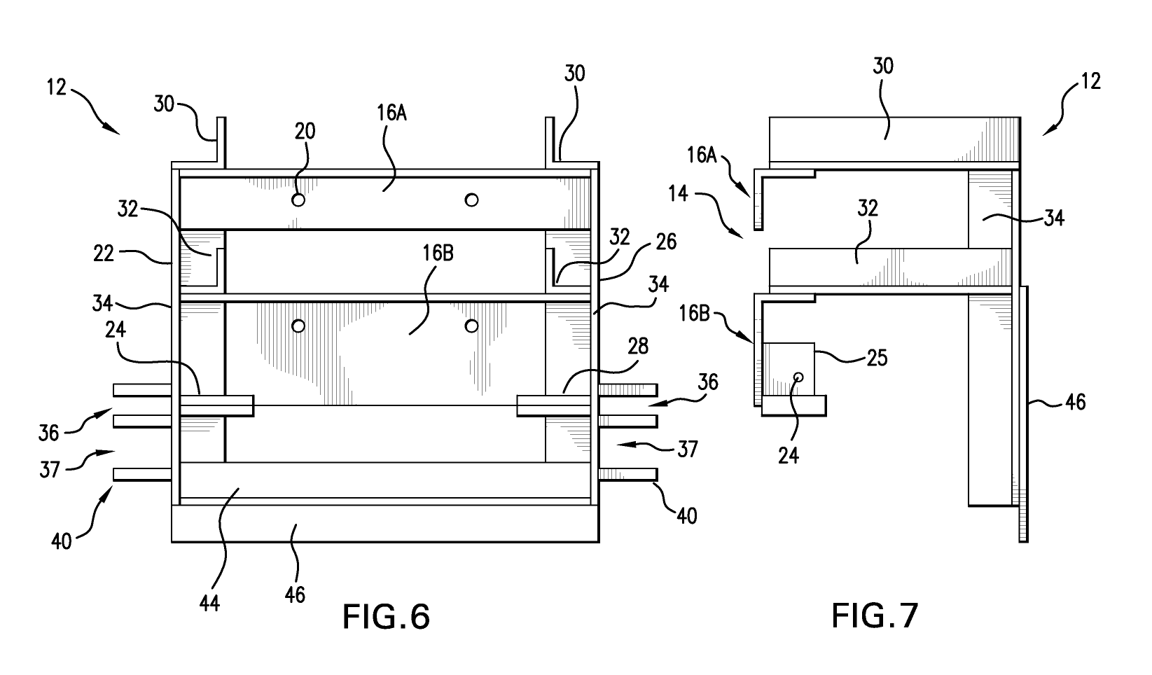

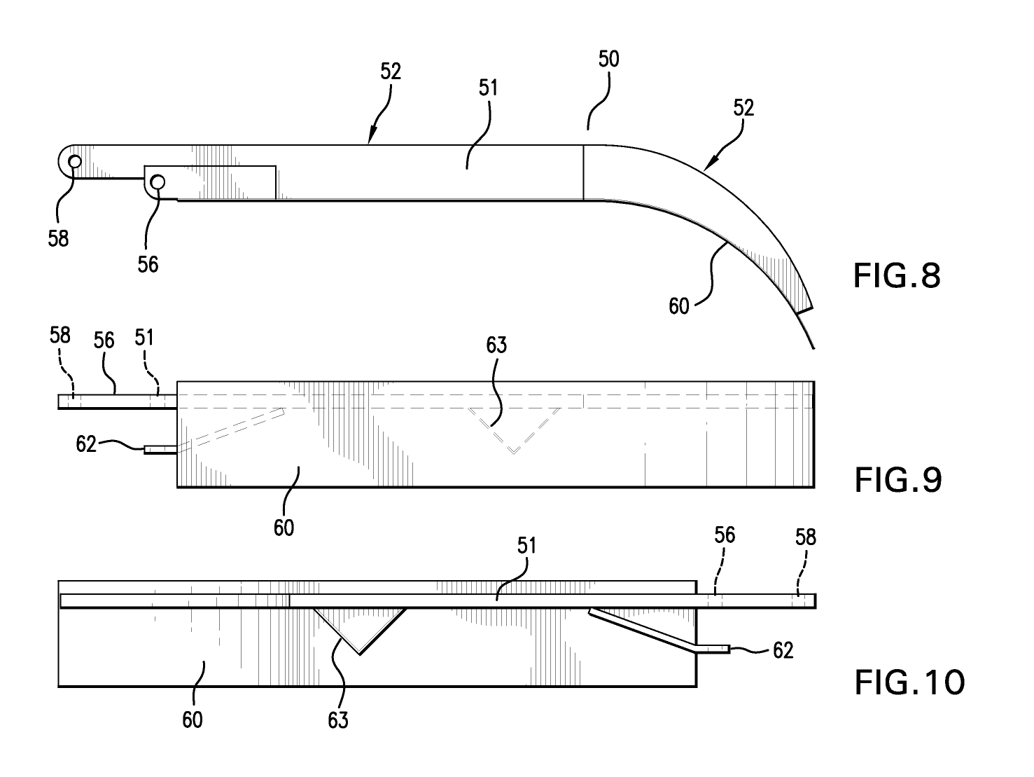

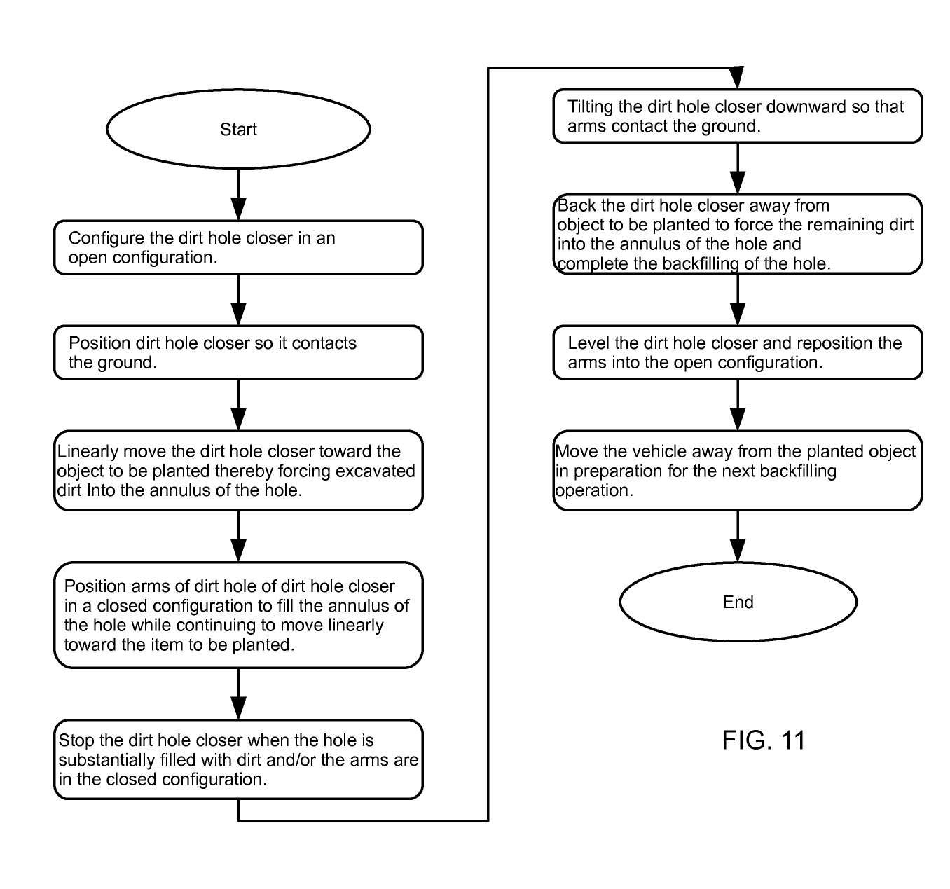

A dirt hole closer 100, as illustrated in FIGS. 1-8, is installed on a universal plate 11 of a skid steer 10, according to some embodiments. FIG. 1 is a front isometric view of the dirt hole closer preparing to fill a hole, according to some embodiments. FIG. 2 is a front isometric view of the dirt hole closer (of FIG. 1) linearly moving excavated dirt to the hole to be filled, according to some embodiments. FIG. 3 is a front isometric view of the dirt hole closer (of FIG. 1) angularly moving excavated dirt to the hole to be filled, according to some embodiments. FIG. 4 is a front isometric view of the dirt hole closer (of FIG. 1) and the backfilled hole, according to some embodiments. FIG. 5 is a plan view of the dirt hole closer (of FIG. 1), according to some embodiments. FIG. 6 is a rear view of the frame of the dirt hole closer (of FIG. 1), according to some embodiments. FIG. 7 is a side view of the frame of the dirt hole closer (of FIG. 1), according to some embodiments. FIG. 8 is a plan view of the left arm of the dirt hole closer (of FIG. 1), according to some embodiments. FIG. 9 is a side view of the left arm of the dirt hole closer (of FIG. 1) as viewed from the right side, according to some embodiments. FIG. 10 is a side view of the left arm of the dirt hole closer (of FIG. 1) as viewed from the left side, according to some embodiments. FIG. 11 is a flow diagram for a method to perform a dirt hole filling operation, according to some embodiments.

As shown in FIGS. 1-10, the dirt hole closer 100 includes a frame 12, a push blade 46, a right arm 48, a left arm 50, a right arm actuator 66, and a left arm actuator 68. The frame 12 is comprised of a rear 14, a left side 22, a right side 26, and a front 42. The push blade 46 is mounted to the front 42 of the frame 12. The right arm 48 and the left arm 50 are each comprised of a support member 51, having a straight section 52 and a curved section 54, a pivot hole 56, an actuator hole 58, a flat plate 60, a pivot brace 62, and an angle brace 63. Elements 12, 44, 48, and 50 are generally composed of carbon steel, although any or all of these elements may alternately be composed of any high strength metal or composite material including an amalgam of different metals or materials. The right arm actuator 66 and the left arm actuator 68 are commercially available dual action hydraulic actuators.

Referring specifically to FIG. 1, the dirt hole closer 100 is attached to the lifting arms on the front of a skid steer 10. As shown in FIG. 1, the frame 12 is mounted to the universal plate 11 of the skid steer 10. According to some embodiments, the frame 12 my include a universal plate 11 that is integrated into the design of the frame 12, as is commonly known in the art. The frame 12 consists of a rear 14, a left side 22, a right side 26, and a front 42. (Ref. FIGS. 6 and 7) According to some embodiments, the components of the frame 12 are oriented to form a shape that generally resembles an inverted chair and are rigidly and permanently secured to each other as specified through fastening means, such as welding. The rear 14 comprises two horizontal members 16A and 16B, according to some embodiments. The horizontal members 16A and 16B are constructed of 3×3×⅜ and 3×5×⅜ inch angle iron, respectively. According to some embodiments, the horizontal members 16A and 16B are 21 inches long and have four mounting holes 20 are located on the horizontal members 16 (Ref. FIG. 6). The mounting holes 20 are 9/16 inch holes and are spaced 8¼ inches horizontally and 6 inches vertically. The size and location of these the mounting holes 20 may be varied as needed to accommodate the mounting arrangements that exist for different vehicles. In some embodiments, the rear 14 is configured to interface with the universal plate 11 of the skid steer without the use of bolts. The horizontal members 16A and 16B are securely attached to the right side 22 and the left side 26.

The right side 22 and the left side 26 are similar in size and shape and are generally constructed of the same components (See FIGS. 5-7). As shown in FIG. 7, The right side 22 consists of a right block 24, an upper horizontal member 30R, a lower horizontal member 32R, a vertical member 34R, a hinge 36R, and a hinge support 40R. The left side 26 consists of a left block 28, an upper horizontal member 30L, a lower horizontal member 32L, a vertical member 34L, a hinge 36L, and a hinge support 40L. The upper horizontal members 30R and 30L and the vertical members 34R and 34L are constructed of 2.5×2.5×⅜ inch angle iron. The lower horizontal members 32R and 32L are constructed of 2×2×⅜ inch angle iron. The upper horizontal members 30R and 30L and the lower horizontal members 32R and 32L are approximately 12 inches long. The overall length of the right side 22 and the left side 26 is approximately 13 inches. The vertical members 34R and 34L are 16 inches long. The upper horizontal members 30R and 30L, the lower horizontal members 32R and 32L, and the vertical members 34R and 34L are securely attached to each other.

A hinge 36R and 36L and a hinge support 40R and 40L are securely attached to each vertical member 34R and 34L (Ref. FIG. 6). Each hinge 36R and 36L is constructed of ½ inch thick steel and has 1 1/32 inch diameter holes positioned 1½ inches from the vertical member 34R/34L to which it is attached. The hinges 36R and 36L each have a 2 1/16 inch gap 37. Each hinge support 40R and 40L is constructed ½ inch thick steel and has a 1 1/32 inch diameter hole positioned 1½ inches from the vertical member 34R/34L to which it is attached. The hinge supports 40R and 40L are positioned approximately 2 inches below the respective hinge and are located such such that a pin 64 can be inserted through the holes in the hinges 36R and 36L and the hinge supports 40R and 40L.

The sizes and locations of the right block 24 and the left block 28 are unique to each block. As shown in FIGS. 5 and 7, the right block 24 is positioned proximal to the rear 14 of the frame 12 and measures 1×3¾×3 inches. The right block 24 has an actuator hole 58 with a 1 1/32 inch diameter located 1¼ inches from the end and 1¼ inch from the side. As shown in FIG. 5, the left block 28 is positioned proximal to the front 42 of the frame 12 and measures 1×4¼×3 inches. The left block 28 has an actuator hole 58 with a 1 1/32 inch diameter located 1¼ inches from the end and 1¼ inch from the side. The right block 24 and the left block 28 are constructed of plate steel.

The front 42 consists of a brace 44 and serves as an attachment point for the push blade 46 (Ref. FIGS. 6 and 7). The brace 44 is constructed of 2×2×1/4 inch angle iron and is 20 inches in length. The brace 44 is securely attached to the vertical members 34R and 34L. The push blade 46 is a ¼ inch thick steel plate that measures 11½×21 inches. The push blade 46 is securely attached to the brace 44 and the vertical members 34R and 34L by means such as welding. As shown in FIG. 7, the push blade 46 is positioned so that the lower edge of the push blade extends approximately 1½ inches below the lower-most portion of the vertical members 34R and 34L. The right arm 48, left arm 50 and push blade 46 are positioned such that the lower edges of each item are substantially coplanar.

Although the cross-sectional shapes and sizes of the components comprising the frame are specified, other materials of varying cross-sectional shapes and sizes may be substituted provided the material is of suitable strength.

Referring specifically to FIG. 5, the right arm 48 and the left arm 50 are pivotally attached to the frame 12 at hinges 36R and 36L. The right arm 48 and the left arm 50 consist of a support member 51, a flat plate 60, a pivot hole 56, an actuator hole 58, a pivot brace 62, and an angle brace 63. The support member 51 has a straight section 52 and a curved section 54. The straight section 52 of support member 51 is approximately 40 inches long, 4 inches wide, and 1 inch thick. The curved section 54 is approximately 14 inches long, as measured along the inner contour, and has an 18 inch radial curvature. The support members 51 of the right arm 48 and the left arm 50 are positioned in the gap of the hinges 36R and 36L such that the pivot holes 56 located on the straight sections 52 align with the pivot holes 52 located on the hinges 36R and 36L.

The pivot brace 62 is securely attached to both the right arm 48 and left arm 50. (See FIG. 8). The pivot brace 62 is constructed of a ½ inch steel plate measuring 2×10 inches and has a 20° bend located 2½ inches from the end that is proximal to the hinge 36. The pivot brace 62 has a 1 1/32 inch pivot hole 56 that is positioned 3 1/16 inches directly beneath the pivot hole 56 on the support members 51 The pivot holes 56 on the pivot braces 62 align with the pivot holes 56 located on the hinge 36R and hinge 36L. A pin 64 is used to pivotally secure the right arm 48 and left arm 50. The pin 64 passes through the pivot holes 56 in hinge 36R and hinge 36L, the support members 51, the pivot braces 62, and the pin supports 40.

The flat plate 60 is securely mounted to the inner contour of the support member 51. (See FIGS. 8-10). The flat plate 60 is constructed of a ¼ inch steel plate measuring 52×8 inches. The flat plate 60 is positioned such that the upper edge of the flat plate 60 extends approximately 1 inch above the upper surface of the support member 51 and the forward end of the flat plate 60 extends 3 inches beyond the end of the curved section 54 of the support member 51. As shown in FIGS. 9 and 10, the angle brace 63 is securely mounted to the support member 51 and flat plate 60.

The actuator hole 58 is located 6½ inches from the pivot hole 56 on each support member 51 positioned proximal to the end of the support member 51 that is oriented proximal to the frame 12. (See FIG. 8).

The right arm actuator 66 and left arm actuator 68 are dual acting commercially available hydraulic cylinders that can be extended from 16 to 22 inches. The right arm actuator 66 is pivotally attached to the right arm 48 and left block 28 and the left arm actuator 68 is pivotally attached to the left arm 50 and right block 24. The attachment point at the right arm 48 and left arm 50 are the dynamic ends of the actuators and the attachment point at the left block 28 and right block 24 are the static attachment points.

During use, the dirt hole closer 100 is attached to the front of the skid steer 10 at the universal plate 11 which is attached to the lift arms of the skid steer 10. Once attached to the skid steer 10, the operator positions the skid steer 10 near the tree to be planted and manipulates the dirt hole closer 10 into the open configuration (See FIG. 1). The dirt hole closer 10 is manipulated from the open to the closed configuration using the right arm actuator 66 and left arm actuator 68. When the dirt hole closer 10 is in the open configuration, the curved sections 54 of the right arm 48 and the left arm 50 are substantially located in outboard positions. The resulting configuration of the right arm 48, push blade 46, and left arm 40 resembles a semi-circle.

From this position, the operator drives the skid steer 10 toward the tree to be planted with the dirt hole closer 100 to push to the excavated dirt toward the general direction of the tree (See FIG. 2). When the skid steer 10 is properly positioned, the right arm actuator 66 and left arm actuator 68 are activated, causing the right arm 48 and left arm 50 to transition to the closed configuration of the dirt hole closer 100 (See FIG. 3). During the transition to the closed configuration, the flat plates 60 on the right arm 48 and left arm 50 push excavated dirt toward the center of the dirt hole closer 100 and into the annulus of the hole surrounding the tree. In the closed configuration, the right arm 48 and left arm 50 are substantially parallel. Throughout this operation, the height and angle of the dirt hole closer 100 is controlled by manipulating the position of the universal plate 11 using the lift arms of the skid steer 10. FIG. 11 is a flow diagram for a method to perform a dirt hole filling operation, according to some embodiments.

The previously described versions of the present invention have many advantages. For example, the device utilizes the forward linear motion of the skid steer to push the excavated dirt toward the hole and utilizes angular motion of the arms and rearward linear motion of the vehicle to complete the backfilling operation. In addition, the device provides a means to readily manipulate the filler material into a hole with an object projecting above the ground level. These attributes allow the operator to efficiently perform backfilling operations with only one forward and one rearward motion and eliminate the need for manual backfilling of a hole.

Another advantage of the invention is that the dirt hole closer is positioned within clear view of the operator and does not impair the forward vision of the operator. The location of the device in close proximity to the operator's seat allows the operator to easily monitor the operation and control the device to ensure that the hole is sufficiently backfilled.

Yet another advantage of the invention is that the device is strong and durable yet simple to manufacture. The strength of the design is important because it allows the device to be used reliably for large agricultural projects, urban forestry projects, or construction projects. As a result, the operator can fully realize the efficiency gains of the device.

Still another advantage of the device is that is comprised of a minimum number of moving components subject significant wear or failure over time. The majority of the components are constructed using readily available materials or are commercially available parts. Accordingly, the device has a limited number of uncomplicated components that can be easily procured or manufactured.

Yet another advantage of the invention is that no modification to the skid steer is required for installation. The invention itself is also versatile because it may be designed using customized dimensions for a variety of styles and sizes of skid steers or similar utility vehicles.

While the invention has been described with respect to a limited number of embodiments, those skilled in the art will appreciate numerous modifications and variations therefrom. It is intended that the appended claims cover all such modifications and variations as fall within the true spirit and scope of the invention. Any element in a claim that does not explicitly state “means for” performing a specified function is not intended to be interpreted as a “means” clause as specified in 35 U.S.C. §112, ¶6.

1. An earth working apparatus for a vehicle, the apparatus comprising:
(a) a frame removably attached to the vehicle;
(b) a left arm pivotally attached to the frame;
(c) a right arm pivotally attached to the frame;
(d) a means for manipulating the left arm and the right arm; and
(e) a push blade securely attached to the frame.

2. The apparatus as defined in claim 1, wherein the means for manipulating the left arm and the right arm is accomplished using dual action hydraulic actuators.

3. The apparatus as defined in claim 1, wherein the left arm and the right arm are each comprised of a support member, having a straight section, a curved section, a pivot hole, and an actuator hole, a flat plate, a pivot brace, and an angle brace.

4. The apparatus as defined in claim 1, wherein the left arm and the right arm are each pivotally attached to the frame using a hinge, a hinge support, and a pin.

5. The apparatus as defined in claim 1, wherein the left arm, the right arm, and push blade each have lower edges that are substantially coplanar.

6. A front mounted earth working apparatus for a skid steer, the apparatus comprising:
(a) a frame removably attached to the skid steer;
(b) a left arm pivotally attached to the frame;
(c) a right arm pivotally attached to the frame;
(d) a means for manipulating the left arm and the right arm; and
(e) a push blade securely attached to the frame.

7. The apparatus as defined in claim 6, wherein the means for manipulating the left arm and the right arm is accomplished using dual action hydraulic actuators.

8. The apparatus as defined in claim 6, wherein the left arm and the right arm are each comprised of a support member, having a straight section, a curved section, a pivot hole, and an actuator hole, a flat plate, a pivot brace, and an angle brace.

9. The apparatus as defined in claim 6, wherein the left arm and the right arm are each pivotally attached to the frame using a hinge, a hinge support, and a pin.

10. The apparatus as defined in claim 6, wherein the left arm, the right arm, and push blade each have lower edges that are substantially coplanar.
